(19) United States
(12) Patent Application Publication
(10) Pub. No.: US 2026/0170135 A1
(43) Pub. Date: Jun. 18, 2026

(54) CYBERSECURITY UPDATE DEPLOYMENTS

(71) Applicant: Lemon Inc., Grand Cayman (KY)

(72) Inventors: Kenney HE, Wilmington, DE (US); Wei QIU, Wilmington, DE (US)

(21) Appl. No.: 18/986,514

(22) Filed: Dec. 18, 2024

(51) Int. Cl. G06F 21/56; G06F 21/57

(52) U.S. Cl. CPC G06F 21/566; G06F 21/57

(57) ABSTRACT

Methods, systems, and apparatus, including computer programs encoded on computer storage media, for cybersecurity update deployments. One of the methods includes scanning the network of computing devices to access respective tags assigned to each computing device; processing results of said scanning in accordance with a decision-tree based logic that accords weights to a plurality of factors when identifying an indication of malware presence or absence, on each computing device; and responsive to identifying an indication of malware presence or absence, rescheduling an update for at least one computing device of the network of computing devices.

### BACKGROUND

The field of cybersecurity faces significant challenges in preventing malware and mitigating its effects on computing systems. Malware, which includes viruses, worms, and ransomware, evolves rapidly, exploiting new vulnerabilities and circumventing existing security measures. Updating security systems, e.g., to include rules or procedures for novel threats, can require significant bandwidth. Thus, updating security systems can result in increased computational and/or energy costs. If no additional computational resources are available, such updating can result in decreased bandwidth which can result in processing errors or dropped requests.

### SUMMARY

This specification describes technologies for detecting malware on computing networks. In general, one innovative aspect of the subject matter described in this specification can be embodied in methods that include the actions of scanning, using a set of worker threads, the network of computing devices to access respective tags assigned to each computing device, wherein each computing device has been tagged based on one or more features specific to each computing device; processing, using the set of worker threads, results of said scanning in accordance with a decision-tree based logic that accords weights to a plurality of factors when identifying an indication of malware presence or absence, on each computing device; and responsive to identifying an indication of malware presence or absence, rescheduling an update for at least one computing device of the network of computing devices, wherein the update comprises a software installation or an upgrade to an existing software installation. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: The one or more features specific to each computing device comprise at least one of the following: a characteristic of an operating system installed on an underlying computing device, a characteristic of a non-system software installed on the underlying computing device, a characteristic of a hardware configuration of the underlying computing device, or a characteristic of a network configuration of the underlying computing device. Feature 2: Scanning comprises: determining whether a computing device is equipped with the software installation or the upgrade to the existing software installation. Feature 3: Determining is based on, at least in part, the respective tags assigned to each computing device. Feature 4: Each computing device is initially assigned one or more tags, and wherein each computing device can have an increased number of tags after initial assignment of the one or more tags. Feature 5: Actions include determining a workload for scanning the network of computing devices and processing the scanning results; and dividing the workload among the plurality of worker threads for scanning and processing the results of said scanning in parallel. Feature 6: Actions include, responsive to changes in the workload for said scanning and processing, adding one more worker thread to, or removing one worker thread from, the plurality of worker threads. Feature 7: Actions include shuffling the plurality of worker threads when scanning the network of computing devices and processing the results thereof after the scanning has started. Feature 8: Actions include revising the decision-tree based logic using a machine learning technique to change the weights accorded to the plurality of factors when identifying the indication of malware presence, or lack thereof, on each computing device. Feature 9: The rescheduling comprises: responsive to determining a missing update, performing one of: dispatching the missing update, prioritizing the update ahead of an original schedule, or delaying the update after the original schedule. Feature 10: Actions include testing each update using one or more canaries in a controlled environment before rolling out the update.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system with partitioned networks.

FIG. 2 is an example process of deploying models for a security system.

FIG. 3 shows an example security system for deploying or not deploying security updates.

FIG. 4 is a block diagram illustrating an example of a computer system.

FIG. 5 is a flowchart of an example process for detecting malware.

Like reference numbers and designations in the various drawings indicate like elements.

### DETAILED DESCRIPTION

The timely detection and mitigation of malware can help safeguard systems and data. Existing antivirus solutions typically depend on periodic updates to malware signature databases, usually conducted periodically, e.g., on a monthly basis. This periodic update interval exposes systems to vulnerabilities from new threats that arise between updates. The increasing volume of data and traffic in modern computing systems can increase the likelihood of an attack, the rate of novel attacks, the computational or bandwidth impact of updating to help prevent attacks, or a combination of one or more of these among others.

Techniques described in this specification can help reduce the update interval of antivirus signatures from weekly or monthly to daily or other time intervals. By increasing the frequency of updates, the techniques described can help enhance security systems and data, e.g., by minimizing a time window from when novel threats are developed to when those threats are added to antivirus threat detection lists through interval updates. Techniques described in this specification help to reduce inefficiencies in current update processes. Techniques can include implementing network partitioning, e.g., to manage an increased frequency or volume of updates.

Techniques can include managing a high volume of data and traffic associated with frequent, e.g., daily or other time interval, antivirus updates. Techniques can help ensure that frequent updates do not degrade system performance, e.g., from thundering herd issues. Techniques described can help ensure that frequent updates do not degrade system performance by splitting up requests into smaller requests that require less bandwidth. By splitting up requests, scaling, such as scaling of database storage, may not be required. Techniques can include scaling a threat detection process to handle an increasing volume or variety of malware. Techniques can include ensuring real-time detection and response to zero-day threats. Techniques can include optimizing an update process to quickly incorporate a latest set of online machines. Techniques can balance advanced security measures with monetary and computer processing budget constraints, e.g., providing cost-effective solutions that help maximize performance and/or security while minimizing monetary and/or computer processing costs.

Techniques described in this specification can include a horizontally scaled, partitioned algorithm to facilitate rapid detection and response to emerging malware variants. Techniques can include dividing a network into smaller segments. A load can be distributed efficiently to ensure timely updates across one or more of the partitions without overloading any single part of the network. Techniques can include deploying updates in a controlled manner using canaries, e.g., representations of existing hosts. Canaries can include systems or data configured to attract attacks and, when attacked, canaries can be configured to provide details of the attack to a system control unit. Details of the attack can be used in one or more updates to help an identification system detect or block access in response to detecting a match between an instant interaction and a known type of attack. Canaries can help ensure that any potential issues are identified and resolved before a full rollout. Techniques described can help efficiently manage a high volume of data and traffic associated with daily antivirus signature updates, e.g., ensuring that frequent updates do not degrade system performance. Techniques can be used to scale a threat detection process, e.g., to handle an increasing volume and variety of malware, maintain system efficiency, and provide cost-effective solutions without compromising performance or security.

In some implementations, a system is configured to divide a network into smaller segments. For example, a system can divide a network into smaller, manageable segments to efficiently handle increased update frequency while maintaining a similar sized database. The system can include canary deployments. Canary deployments can allow for updates to be tested in a controlled manner before a full rollout. Canary deployments can help ensure that any potential issues are identified and resolved. Subsequent updates can include fixes or updates generated by the system in response to data collected from one or more canary deployments.

In some implementations, a system reduces an update interval for updating antivirus detection or mitigation processes. For example, a system can reduce an update interval to daily. By reducing an update interval, a system can improve its ability to detect or mitigate new malware threats in real-time. In some implementations, a system partitions or scales a network, e.g., to help ensure that the system can handle increased loads without compromising performance. Techniques described in this specification can provide a scalable solution that is adaptable to various network sizes and configurations. Advanced security measures can be balanced with budget constraints to help ensure cost effective solutions that do not compromise on performance or security.

In some implementations, a system scans a set of hosts based on attributes of the hosts. For example, a system can scan one or more hosts, which can include resources in a network, where each of the hosts satisfy one or more scanning criteria. For example, scanning criteria can include characteristics of a host, such as whether the host is newly built or has missing tags. Scanning criteria can include one or more characteristics. Some example characteristics can include data indicating one or more of: a software version of a host, a date of deployment, a date of a most recent update, available bandwidth, type of data handled, priority level of data handled, processes performed, priority level of processes performed, among others. A system can incorporate inversion logic. Inversion logic can include determining a malware status using obtained characteristics of one or more hosts. Characteristics of hosts can be incorporated into tags. Tags can define one or more hosts. Inversion logic can account for missing tags due to defects, neglect, or newly built systems. Inversion logic can help ensure an algorithm is complete or can help ensure algorithm accuracy, e.g., regardless of missing tags. Inversion logic can account for potential reasons for missing tags, e.g., due to errors in the tagging algorithm itself, the presence of new, previously unknown data, or a combination of these among others. Tagged resources can represent known data. Missing tags can represent either errors or the potential for new discoveries. Design of an algorithm performed by a system can enable an all tag-based solution.

A system can be configured to provide updates while minimizing bandwidth and/or frequency impact. A system can determine whether or not one or more hosts receive, or do not receive, security updates. A system can include a model that uses input data to determine whether or not a host receives, or does not receive, one or more security updates. A model can include decision-tree based logic, one or more machine learning models, or a combination of these among others. A system can determine that some hosts do not require security updates while other hosts do require updates. By not deploying updates to at least some hosts, the system can reduce bandwidth expense. A model of the system for determining whether or not to deploy security updates can be trained to maximize security of a network while minimizing bandwidth usage on security update network packets. Security update network packets can include one or more updates or adjustments to identification or threat response. Sending such packets to host, or worker threads monitoring hosts, can reduce overall available bandwidth of a network. The model can be configured to minimize such reductions in bandwidth while still providing security updates. A system using techniques described in this specification can achieve gapless coverage during installation and updates. Gapless coverage can include not missing a security update necessary to prevent successful attacks on a network. Existing solutions can leave gaps, e.g., from limited security updates or bandwidth-related delays in deploying security updates while minimizing database capacity.

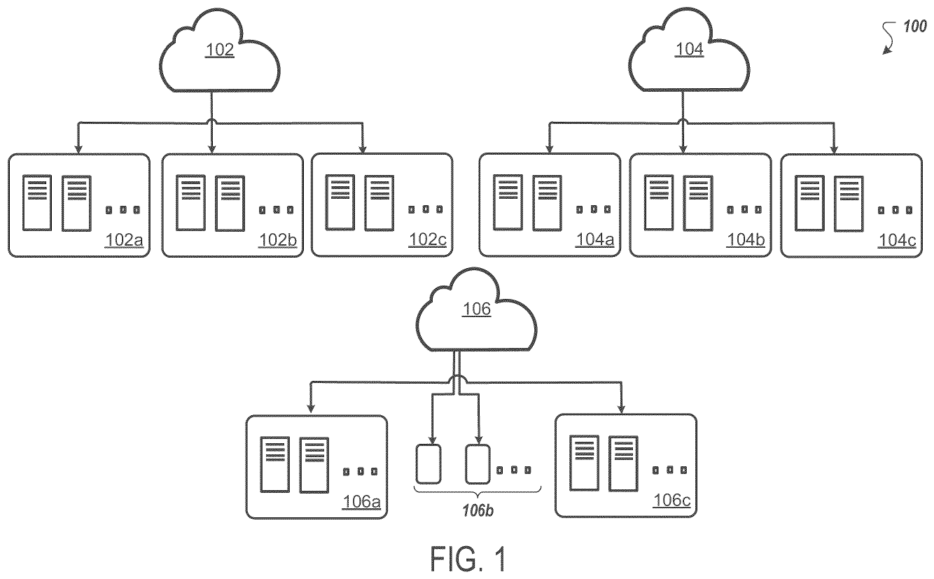

FIG. 1 shows an example of a system 100 with partitioned networks 102, 104, and 106. The networks 102, 104, and 106 each include a set of hosts. For example, the network 102 includes sets 102a, 102b, and 102c. Each of the sets include one or more hosts. For example, the set 102a can correspond to a range of addresses between 10.11.0.0 and 10.11.099.255. The set 102a can be processed by a first worker assigned to the set 102a. Other sets shown in FIG. 1 can similarly be assigned to specific ranges of addresses and assigned to one or more workers for processing. The system 100 can determine a number of workers per host list based on a combination of factors, including at least one of workload distribution, performance optimization, anticipated workload, balancing anticipated workload across hosts, maximizing system performance, minimizing latency, or a combination of these among others.

A worker can include one or more computers configured to perform operations of monitoring, maintenance, or incident responses for a set of one or more hosts. For example, one or more workers can process data related to the set 102a of hosts on the network 102. Monitoring can include monitoring network traffic or system activities, e.g., to detect or respond to potential threats. Maintenance can include determining whether or not systems are up-to-date, e.g., with latest security patches or configurations. Incident responses can include performing one or more operations in response to an identification of an attack, security breach, or other incident. Responses can include mitigation of damage or restoration of normal operations. Actions taken in response to identification or detection of an attack can include isolating one or more affected hosts from a network, e.g., by blocking their communication at the network layer (e.g., layer four). Isolating affected hosts can prevent an attack from spreading laterally and accessing other systems. Responsive actions can include one or more of: (i) implementing firewall rules, e.g., to block known malicious traffic patterns or specific IP addresses associated with the attack, (ii) checking that systems are running one or more latest security patches or updates to address vulnerabilities that might have been exploited by an attack, or (iii) generating a notification including data obtained based on a detection of an attack, e.g., to be sent to connected systems, security personnel, administrators, or a combination of these among others.

The set 102a can include one or more hosts. The one or more hosts can be connected to the network 102 or other networks, such as the network 104 or the network 106. The hosts can include devices, such as computers, smartphones, servers, IoT devices, or a combination of these among others. Each host can have a unique address within the network 102. The unique address can allow the host to communicate with other devices. Each host can have vulnerabilities that are protected by one or more workers. Access can be controlled such that only authorized users and devices can access certain hosts to prevent unauthorized access. Hosts can monitor or save logs that record host activities or requests from connected devices.

A network can include one or more sets of hosts. In the network 106, a number of sets are represented by item 106b. A total number of hosts in a host set can be any number, such as eight, ten, twenty, one hundred, one thousand, among others.

In the example of FIG. 1, the networks 102, 104, and 106 are partitioned. A network can include a number of hosts that provide data or access to the network. A set of N workers can process data for the hosts in the network. The N workers can perform operations including identifying and mitigating malware threats or security attacks that involve, e.g., a user device, such as a smartphone, accessing data from a host without permission or attempting to infect computer systems of the host.

In some implementations, the system 100 generates tags for one or more hosts. For example, the system 100 can generate tags to identify one or more hosts based on characteristics of the one or more hosts. The number of tags can vary from system to system. Generated tags can be assigned to a range of network addresses. In some cases, each network address in a range can correspond to one or more hosts in the network, such as the set of hosts 102a.

In some implementations, the system 100 generates tags and assigns workers and hosts based on generated tags. For example, the system 100 can assign each host in the host set 102a to a first tag. The system 100 can assign one or more workers configured to process data or scan one or more hosts of the host set 102a for malware or threats to the first tag as well. A given worker can work for multiple hosts. A given worker assigned to a first tag can perform operations, such as identification and mitigation of malware or cybersecurity threats, for one or more hosts that have been assigned the first tag, e.g., because an address of the one or more hosts fall within a range assigned to the first tag.

In some implementations, the system 100 generates tags that indicate characteristics of a host, worker, or other component of the system 100. For example, a tag can indicate whether or not a host should receive a security update or not. A tag can include data indicating a time of a most recent security update, a difference between a current security software and an updated security software, uptime or downtime of the host, a processing priority of data or processing of the host, a criticality of operations or data (e.g., of the host), operating system, software versions, hardware configuration, network Classless Inter-Domain Routing (CIDR), or a combination of these among others.

A system, such as the system 100, can generate one or more tags. The tags of a network can be defined as

$${\sum }_{n = 1}^{N} {host}_{tagn}$$

where n represents the number of workers of a network, e.g., eight or some other number depending on computational limitations of a given system. In some cases, the tags can represent each host within a network, or multiple networks, that includes multiple hosts, such as each host within the system 100. The number of workers can be assigned to one or more hosts. A number of hosts can be twenty thousand, one hundred thousand, a million, among others. Tags of a network can be further defined as n11_0_{tag1}+n12_0_{tag2}+n13_0_{tag3}+n11_1_{tag4}+n12_1_{tag5}+n13_1_{tag6}+n11_2_{tag7}+n12_2_{tag8}. n11_0_{tag1} can represent a range of addresses between 10.11.0.0 and 10.11.099.255. n12_0_{tag2} can represent a range of addresses between 10.12.0.0 and 10.12.099.255. n13_0_{tag3} can represent a range of addresses between 10.13.0.0 and 10.13.099.255. n11_1_{tag4} can represent a range of addresses between 10.11.100.0 and 10.11.199.255. n11_2_{tag7} can represent a range of addresses between 10.11.200.0 and 10.11.255.255. n12_1_{tag5} can represent a range of addresses between 10.12.100.0 and 10.12.199.255. n12_2_{tag8} can represent a range of addresses between 10.12.200.0 and 10.12.255.255. n13_1_{tag6} can represent a range of addresses between 10.13.100.0 and 10.13.199.255. Each of tags one through eight can correspond to a worker where N equals eight. A worker can include one or more computers configured to perform one or more operations on data or communications to or from one or more hosts.

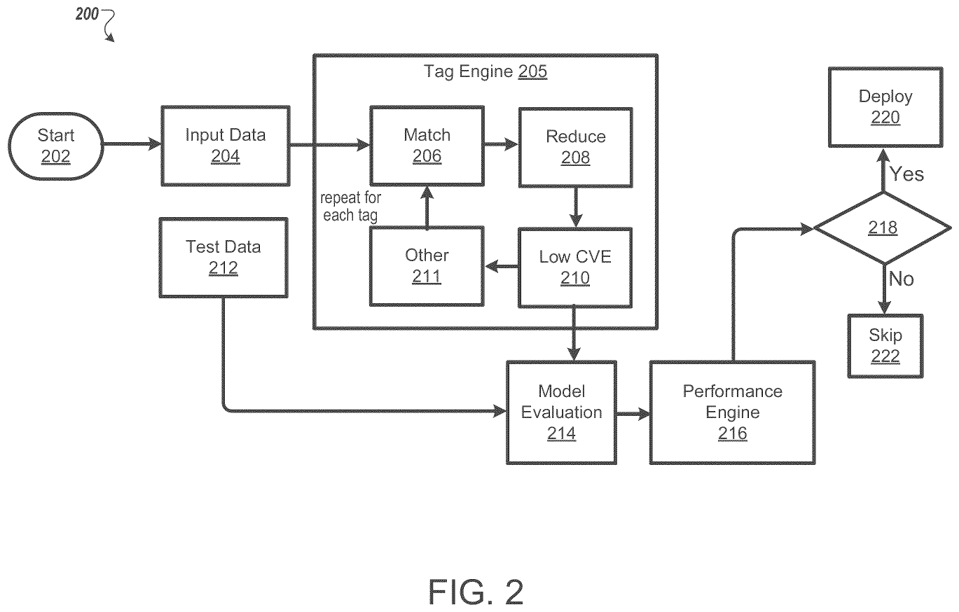

FIG. 2 is an example process 200 of deploying models for a security system. At start 202, the process 200 includes providing input data 204 to a tag engine 205. Input data 204 can include one or more rules to be enforced by one or more workers.

The tag engine 205 can perform operations for generating a model for evaluation using a model evaluation process 214. The tag engine 205 can include one or more operations to be performed for each tag. A tag can include a tag assigned to one or more addresses within an address space and to one or more workers of N workers. For example, a tag can include n11_0_{tag1}. Operations to be performed for each tag can include operations match 206, reduce 208, Low CVE 210, and other 211. Other 211 represents one or more additional operations. Operations shown in FIG. 2 can be optional. For example, the tag engine 205 can operate using a subset of the operations discussed, such as only the match 206 and reduce 208 operations. Operations can include ignoring rules that are the same as the rules from a previous time period, e.g., included in yesterday's rule set. Operations can include ignoring rules if the number of rules is lower than rules from yesterday. For example, the match 206 operation can include matching a number of rules stored from a previous time period, e.g., yesterday, and comparing the stored number of rules to a current number of rules, e.g., included in the input data 204. If the stored number of rules is greater, the tag engine 205 can store data indicating that rules of the input data 204 are to be ignored, e.g., because refactoring has been done.

In some implementations, the tag engine 205 performs one or more preliminary operations using tag-based data. For example, the input data 204 can include data representing one or more tags that indicate characteristics of one or more hosts of a network. The tag engine 205 can perform operations on the input data 204 to generate data to be used in the model evaluation 214 process. In some cases, the tag engine 205 eliminates redundant tags, summarizes tag information, reformats tag information, adds additional information, generates tags where the input data 204 does indicate tags but indicates raw data from scanning one or more hosts, or a combination of these among others.

In some implementations, the input data 204 is generated using a sorting process, such as an equal bucket algorithm. For example, a processing device, such as a network controller, can perform a process corresponding to an equal bucket algorithm where, within the equal bucket algorithm the number of hosts from API and from a database query of uncompleted hosts in an operational state can be the same. An example format of the input data 204 includes “n204_0” and “n214_0.” The input data 204 can include data that represents a tag, e.g., indicating a worker that can be assigned processing tasks from one or more hosts.

In some implementations, match process 206 can perform matching using data representing one or more databases, e.g., indicated by the input data 204. Input to the match process 206 can include one or more tags or a hash value, e.g., corresponding to one or more tags. An example hash value can be “b4cc17abfbb036af1addf7e6afcc7b664e129f80e5f16cb56b2c8431a03c9c69”. The match process 206 can include determining whether one or more hashes provided as input are the same. If so, one or more additional operations, such as deploying one or more software updates or a reduce process 208 can be skipped.

The reduce process 208 can include determining whether or not a version of software running on a corresponding worker or host is older than a current version. For example, input to the reduce process 208 can include a version of software used by a worker or host, such as version: 1.9.0.327. The reduce process 208 can compare the input to a current version, e.g., version: 1.9.0.440. The reduce process 208 can determine whether the input data indicates a version that is older than the current version. In response to determining that the input data indicates a version that is older than the current version, the reduce process 208 can deploy one or more software updates to the worker or host.

A low common vulnerabilities and exposures (CVE) process 210 can receive input data indicating a new CVE total indicating a count of CVEs corresponding to a high or critical classification. The low CVE process 210 can include determining whether or not a current CVE value is greater than a threshold value, e.g., zero. In response to the CVE value being greater than the threshold value, the low CVE process 210 can include skipping additional processes, such as deploying one or more software updates.

An additional process, labeled as other process 211, can receive input including one or more inputs used in the match process 206, the reduce process 208, or the low CVE process 210. The other process 211 can include determining whether or not any input information for other processes is missing. The other process 211 can determining whether any input information is missing and, in response to determining that one or more input information is missing, generate a deployment instruction, e.g., to deploy a new installation and update all instruction for one or more hosts or workers.

A model evaluation process 214 can performing a matching operation for test data 212. The test data 212 can include tags marked as a canary, e.g., before starting. Canaries can include representations of existing hosts or systems, such as good representations of existing hosts or systems, or data configured to attract attacks. Implementations may also include tags marked for honeypot type of hosts. Input data to the model evaluation process 214 can include a set of one or more values, e.g., (hash value, version, 0, TRUE), where the hash value can indicate a hash of a database identifier, e.g., used in the match process 206. Version can indicate a version of software running on a host or worker. The data included in the test data 212 can be compared by the model evaluation process 214 with data from the tag engine 205. For example, one or more values generated by the tag engine 205 can be compared with the test data 212. The test data 212 can include data expected for good performance or a specific operation to occur, e.g., for deployment of new software. The model evaluation process 214 can determine whether or not data from the test data 212 and data from the tag engine 205 match. If the model evaluation process 214 determines that the data match, the model evaluation process 214 can skip one or more operations, such as deploying one or more software updates to one or more hosts or workers.

A performance engine 216 can receive input from the model evaluation process 214. The performance engine 216 can determine an amount of time to process one or more operations described and shown in regard to FIG. 2. The performance engine 216 can determine whether the time to process satisfies or does not satisfy an expected processing time. For example, the performance engine 216 can compare a measure time to process, such as ten milliseconds, with an expected time to process, such as fifteen milliseconds. The performance engine 216 can determine one or more rescheduling tasks based on the comparison. The performance engine 216 can determine if there is a network issue, e.g., because a time to process exceeds an expected time to process. In some cases, the performance engine 216 can reschedule with incomplete tags—e.g., one or more tags are incomplete to assign one or more workers to one or more hosts.

The process 200 includes a decision 218 for whether or not to deploy one or more software updates or not. For example, the performance engine 216 can provide data to the decision block 218. The process 200 can include deploying one or more updates if an input value indicates TRUE or skip deployment if an input value indicates FALSE.

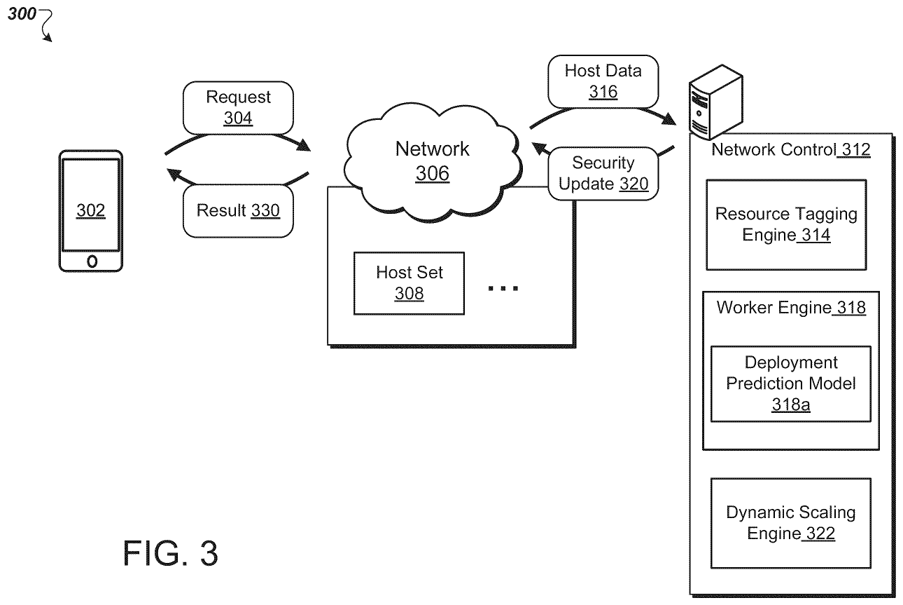

FIG. 3 shows an example security system 300 for deploying or not deploying security updates. The security system 300 includes a device 302, a network 306, and a network control 312. The device 302 is communicably connected to the network 306. The network control 312 is configured to control aspects of the network 306. The network control 312 determines whether or not to update security components on the network 306. The network control 312 can reduce a number of security updates for a given amount of security protection, thereby reducing bandwidth usage for security update processing. The network control 312 can be a part of, or separate from, the network 306. A worker engine 318 of the network control 312 can include one or more computers communicably connected to the host set 308 either physically or via one or more communication networks.

The network 306 can be configured to provide data or services for multiple devices, such as the device 302. In the example of FIG. 3, the device 302 sends a request 304 to the network 306. The network 306 can include a number of host sets that are monitored by one or more workers. For example, the network 306 can include a host set 308. The host set 308 can include data or processes used by the device 302, such as data or processes of a social media platform with which the device 302 accesses an associated account.

In some implementations, the network control 312 generates tags for one or more networks. For example, the network control 312 can obtain host data 316. The host data 316 can be obtained based on a scan of one or more host machines. In some cases, hosts provide data by sending information over the network 306 to the network control 312. A resource tagging engine 314 of the network control 312 can obtain the host data 316 and generate one or more tags for one or more hosts. In some cases, hosts can be referred to as resources, e.g., resources that provide data or operations for one or more devices that request corresponding data or operations.

The resource tagging engine 314 can generate tags for one or more hosts that indicate at least some characteristic of the one or more hosts. For example, the resource tagging engine 314 can generate tags for one or more hosts of the host set 308. The tags can indicate characteristics of the host set 308 or hosts within the host set 308. The resource tagging engine 314 can be configured to assign tags to hosts based on a host's characteristics or configuration. For example, the resource tagging engine 314 can assign tags based on operating system, software versions, hardware configuration, network CIDR, criticality, or a combination of these among others.

In some implementations, the worker engine 318 monitors and processes data related to the host set 308. The worker engine 318 can provide security monitoring, logging, connection blocking, threat identification, or other services for the host set 308. The worker engine 318 can determine whether or not the host set 308 receives a security update. Based on the determination by the worker engine 318, the network control 312 can either deploy, or not deploy, a security update.

The worker engine 318 includes a deployment prediction model 318a. The deployment prediction model 318a can include one or more machine learning models, decision trees, or a combination of these among others. The deployment prediction model 318a can be generated based on one or more training sessions. For example, the deployment prediction model 318a can be trained to determine whether or not an update is required based on historical data. Historical data can include historical tags for one or more hosts and historical threats, or simulated threats, to the one or more hosts. The deployment prediction model 318a can predict whether or not to update one or more hosts based on tags of the hosts. The deployment prediction model 318a can be adjusted based on whether or not, based on historical data, the deployment prediction model 318a predicted correctly whether or not to update security processes for the hosts. A correct prediction can include determining to deploy a security update prior to a security threat, determining not to deploy a security update prior to no security threats, determining not to deploy a security update when an update is already installed, determining to deploy an update when the update is not installed, or a combination of these among others.

The resource tagging engine 314 can provide data to the worker engine 318 indicating tags of the host set 308. The worker engine 318 can provide the data indicating the tags to the deployment prediction model 318a. The deployment prediction model 318a can provide output data indicating whether or not a security update for the host set 308 should be deployed. In response to obtaining the output from the deployment prediction model 318a, the network control 312 can either provide the security update 320 to the network 306 or not provide the security update 320. FIG. 3 shows a case where the network 306 provides the security update 320 for the host set 308. In some cases, the network control 312 determines that a given host set should not be updated, e.g., based on output from the deployment prediction model 318a. The deployment prediction model 318a may determine at one time to not deploy a security update but, at a later time, determine to deploy a security update for a given set of one or more hosts.

In some implementations, the security update 320 includes enrichment for yet another recursive acronym (YARA) for identifying or classifying malware, e.g., by creating descriptions of malware families based on textual or binary patterns. The security update 320 can includes additional textual descriptions or other data that can be used by one or more processes to help identify or classify malware. In some cases, the processes of identification or classification are performed by a worker corresponding to the network 306, such as the worker engine 318 of the network control 312.

In some implementations, the worker engine 318 is configured to determine if a host already possesses an installation. For example, the worker engine 318 can use one or more tags generated for the host set 308 to determine if one or more hosts of the host set 308 already possesses an installation. A tag can include data indicating a current software version of signatures of software which, when processed by the worker engine 318, indicate whether or not the software is current.

In some implementations, the worker engine 318 determines whether or not to upgrade a security component based on tags assigned to one or more hosts. For example, the resource tagging engine 314 can assign one or more tags to the host set 308. The resource tagging engine 314 can provide the generated tags to the worker engine 318 for processing. Based on the assigned tags, the worker engine 318 can determine whether or not to deploy a security upgrade.

In some implementations, the worker engine 318 is configured to identify missing updates, prioritize critical updates, or optimize update deployment. For example, the worker engine 318 can process one or more tags that indicate previously installed updates, criticality of a given host or set of hosts, criticality of security updates, or a combination of these among others. Tags can be generated to describe one or more available security updates, e.g., indicating whether the update is critical or not, whether it impacts different types of operations, or a combination of these among others. Based on a detection of one or more tags indicating one or more characteristics, e.g., of a host or security update, the worker engine 318 can determine whether or not to deploy a security update.

In some implementations, the worker engine 318 performs operations of a decision tree. For example, the worker engine 318 can determine whether or not one or more characteristics of a host or update are satisfied and, in response, determine whether to update or not update. Examples of characteristics can include: whether or not rules of an update are the same as rules from a previous update already deployed, whether fewer rules are included in the update compared to already deployed, whether the state has been updated or not, whether the update satisfies a priority threshold corresponding to a low priority update, whether the update is in inventory or not, or a combination of these among others. An update in inventory can indicate that the update is available for deployment, e.g., that it's ready to be installed on devices or systems but may not have been deployed yet.

In some implementations, the worker engine 318 uses one or more models to rank updates. For example, the worker engine 318 can determine that one or more updates should be deployed. To avoid bandwidth disruptions, the worker engine 318 can determine when, what order, or a combination of these, to deploy the updates. In general, the worker engine 318 can deploy updates during times of low network usage, such as during night time hours for a portion of the network or other suitable time period. The worker engine 318 can rank updates. For example, characteristics of updates can be captured in tags. The worker engine 318 can provide one or more tags indicating updates to one or more models. The one or more models can be trained machine learning models or other types of models. Trained models can be trained to estimate rankings of updates using training representing correctly ranked updates. Updates can be ranked based on a variety of characteristics, such as criticality, operations affected, required processing resources, or a combination of these among others. The worker engine 318 can rank one or more updates and the ranked updates can be deployed in the order of said ranking. In some cases, the worker engine 318 determines both a ranking and timing of updating.

In some implementations, the network control 312 includes a dynamic scaling engine 322. The dynamic scaling engine 322 can be configured to dynamically adjust the number of workers based on budget constraints or workload demands. For example, the network control 312 can deploy one or more worker engines, such as the worker engine 318. The worker engines can perform processes for one or more host sets, including determining updates. The dynamic scaling engine 322 can be configured to increase or decrease workers. The dynamic scaling engine 322 can balance workload across one or more workers. Workers can perform identification of threats, responsive actions, or other processes. The dynamic scaling engine 322 can detect high bandwidth usage and generate additional workers for processing or reassign one or more workers for processing. The dynamic scaling engine 322 can detect low bandwidth usage and generate additional workers for processing or reassign one or more workers for processing. The dynamic scaling engine 322 can compare bandwidth usage to static or dynamic thresholds to determine whether or not bandwidth usage is high or low, e.g., whether or not bandwidth usage satisfies one or more bandwidth thresholds.

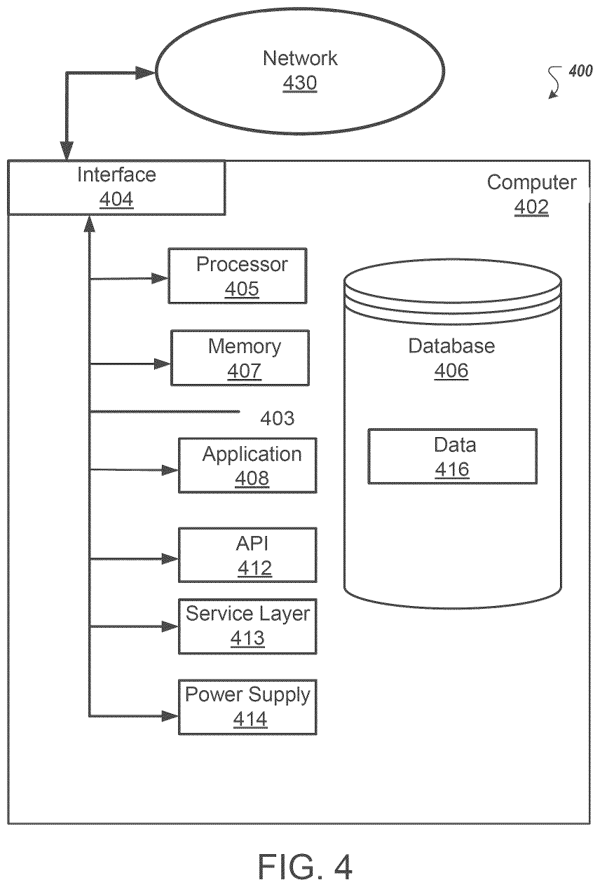

FIG. 4 is a block diagram illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computer that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

The computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users, external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data 416 for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds the previously described data 416 including, for example, data being encrypted and data received from computer servers of other regions.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

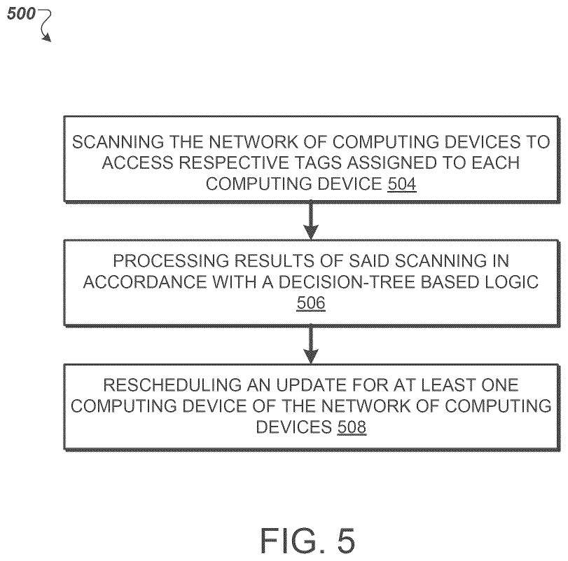

FIG. 5 is a flowchart of an example process 500 for detecting malware. For convenience, the process 500 will be described as being performed by a system of one or more computers, located in one or more locations, and programmed appropriately in accordance with this specification. For example, a system, e.g., the system 100 of FIG. 1, the system 300 of FIG. 3, or the system 400 of FIG. 4, appropriately programmed, can perform the process 500.

The process 500 includes scanning the network of computing devices to access respective tags assigned to each computing device (504). For example, scanning can use a set of worker threads. A set of worker threads can include workers assigned to one or more hosts, e.g., based on address space partitioning. In some cases, each computing device can be tagged based on one or more features specific to each computing device, e.g., a communication address for the given computing device. A computing device can include a host as described in this specification.

In some implementations, the network control 312 of FIG. 3 provides an example of scanning a network to access tags. For example, the resource tagging engine 314 can obtain host data 316 by scanning components of the network 306, such as hosts which can be computing devices. The resource tagging engine 314 can generate tags using the host data 316. In some cases, the host data 316 includes previously generated tags, e.g., by one or more components of the network 306.

The process 500 includes processing results of said scanning in accordance with a decision-tree based logic (506). For example, processing can be performed, at least in part, by a set of worker threads. A set of one or more hosts can be processed by one or more workers. Each or worker can include one or more computer devices configured for processing. In some cases, a decision-tree based logic can accord weights to a plurality of factors, e.g., when identifying an indication of malware presence or absence on each computing device.

In some implementations, the network control 312 of FIG. 3 provides an example of processing results. For example, the worker engine 318 can include a deployment prediction model 318a. The deployment prediction model 318a can include one or more machine learning models, decision trees, or a combination of these among others. The worker engine 318 can obtain tags representing one or more hosts of the network 306 and process the tags to determine whether or not an update should be deployed.

The process 500 includes rescheduling an update for at least one computing device of the network of computing devices (508). For example, rescheduling can be responsive to identifying an indication of malware presence or absence. In some cases, the update includes a software installation or an upgrade to an existing software installation. The network control 312 of FIG. 3 can reschedule one or more updates, e.g., in response to output from the worker engine 318. Rescheduling can include ranking one or more updates for future deployment, timing updates for a future point in time, or a combination of these among others.

In some implementations, rescheduling includes, responsive to determining a missing update, performing one of: dispatching the missing update, prioritizing the update ahead of an original schedule, or delaying the update after the original schedule. For example, the network control 312 can determine one or more of, a time for an update or a ranking of one or more updates, whether or not to include a given update, or a combination of these among others.

In some implementations, features specific to each computing device can include at least one of the following: a characteristic of an operating system installed on an underlying computing device, a characteristic of a non-system software installed on the underlying computing device, a characteristic of a hardware configuration of the underlying computing device, or a characteristic of a network configuration of the underlying computing device.

In some implementations, scanning includes determining whether a computing device is equipped with the software installation or the upgrade to the existing software installation. For example, the network control 312 can scan to determine if a given rule is already installed on a given computer. The worker engine 318 can use one or more tags representing one or more hosts to determine whether or not a given host already has software installed. Determining whether a device is equipped with software installation or a security upgrade to existing software can be based on respective tags for a given computing device, e.g., a host of the host set 308.

In some implementations, each computing device is initially assigned one or more tags. Computing devices can be assigned additional tags after initially being assigned one or more tags. For example, the resource tagging engine 314 can assign initial or additional tags for one or more hosts, which can include one or more computing devices. Each computing device can have an increased number of tags after an initial assignment of the one or more tags. Additional tags can include additional tags to indicate newly installed software, threat incidents, uptime, maintenance requests, or a combination of these among others.

In some implementations, the process 500 includes determining a workload for scanning the network of computing devices and processing the scanning results. In some implementations, the process 500 includes dividing the workload among the plurality of worker threads for scanning and processing the results of said scanning in parallel. For example, the dynamic scaling engine 322 can be configured to divide a workload between one or more workers. A given worker, such as the worker engine 318 can perform processing related to one or more hosts. Additional workers, or fewer workers, can be assigned based on detections by the dynamic scaling engine 322 regarding current workload or bandwidth in a system, such as the system 300.

In some implementations, the process 500 includes shuffling the plurality of worker threads when scanning the network of computing devices and processing the results thereof after the scanning has started. For example, the dynamic scaling engine 322 can determine one or more available worker engines. The dynamic scaling engine 322 can assign workloads to one or more workers during one or more processes, such as when the network control 312 obtains the host data 316, when the resource tagging engine 314 generates one or more tags, when the worker engine 318 processes one or more items of data representing one or more hosts, or at other times.

In some implementations, the process 500 includes revising the decision-tree based logic using a machine learning technique to change the weights accorded to the plurality of factors when identifying the indication of malware presence, or lack thereof, on each computing device. For example, the worker engine 318 can include one or more machine learning models. The one or more models can be trained to adjust one or more weights of a decision tree. The decision tree can be used to identify or detect malware and can include one or more factors that have different weights. For example, one factor may be an IP address from a specific geographic location. In response to detecting one or more threats from that specific geographic location, one or more models can be trained to adjust one or more weights of a decision tree such that subsequent requests from that IP address are more likely to be identified as security threats.

In some implementations, the process 500 includes testing each update using one or more canaries in a controlled environment before rolling out the update. For example, the model evaluation 214 can include a canary deployment using the test data 212. Data indicating an update can be provided by the tag engine 205 and used by the model evaluation 214. Output of the model evaluation 214 processing the test data 212 can be processed by the performance engine 216 to determine whether or not a given update should be deployed.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for detecting malware on a network of computing devices, the computer-implemented method comprising:
scanning, using a set of worker threads, the network of computing devices to access respective tags assigned to each computing device, wherein each computing device has been tagged based on one or more features specific to each computing device;
processing, using the set of worker threads, results of said scanning in accordance with a decision-tree based logic that accords weights to a plurality of factors when identifying an indication of malware presence or absence, on each computing device; and
responsive to identifying an indication of malware presence or absence, rescheduling an update for at least one computing device of the network of computing devices, wherein the update comprises a software installation or an upgrade to an existing software installation.

2. The computer-implemented method of claim 1, wherein the one or more features specific to each computing device comprise at least one of the following:
a characteristic of an operating system installed on an underlying computing device,
a characteristic of a non-system software installed on the underlying computing device,
a characteristic of a hardware configuration of the underlying computing device, or
a characteristic of a network configuration of the underlying computing device.

3. The computer-implemented method of claim 1, wherein said scanning comprises:
determining whether a computing device is equipped with the software installation or the upgrade to the existing software installation.

4. The computer-implemented method of claim 3, wherein said determining is based on, at least in part, the respective tags assigned to each computing device.

5. The computer-implemented method of claim 3, wherein each computing device is initially assigned one or more tags, and wherein each computing device can have an increased number of tags after initial assignment of the one or more tags.

6. The computer-implemented method of claim 1, further comprising:
determining a workload for scanning the network of computing devices and processing the scanning results; and
dividing the workload among the plurality of worker threads for scanning and processing the results of said scanning in parallel.

7. The computer-implemented method of claim 6, further comprising:
responsive to changes in the workload for said scanning and processing, adding one more worker thread to, or removing one worker thread from, the plurality of worker threads.

8. The computer-implemented method of claim 6, further comprising:
shuffling the plurality of worker threads when scanning the network of computing devices and processing the results thereof after the scanning has started.

9. The computer-implemented method of claim 6, further comprising:
revising the decision-tree based logic using a machine learning technique to change the weights accorded to the plurality of factors when identifying the indication of malware presence, or lack thereof, on each computing device.

10. The computer-implemented method of claim 1, wherein the rescheduling comprises:
responsive to determining a missing update, performing one of: dispatching the missing update, prioritizing the update ahead of an original schedule, or delaying the update after the original schedule.

11. The computer-implemented method of claim 1, further comprising:
testing each update using one or more canaries in a controlled environment before rolling out the update.

12. A system comprising:
one or more computers and one or more storage devices on which are stored instructions that are operable, when executed by the one or more computers, to cause the one or more computers to perform operations comprising:
scanning, using a set of worker threads, the network of computing devices to access respective tags assigned to each computing device, wherein each computing device has been tagged based on one or more features specific to each computing device;
processing, using the set of worker threads, results of said scanning in accordance with a decision-tree based logic that accords weights to a plurality of factors when identifying an indication of malware presence or absence, on each computing device; and
responsive to identifying an indication of malware presence or absence, rescheduling an update for at least one computing device of the network of computing devices, wherein the update comprises a software installation or an upgrade to an existing software installation.

13. The system of claim 12, wherein the one or more features specific to each computing device comprise at least one of the following:
a characteristic of an operating system installed on an underlying computing device,
a characteristic of a non-system software installed on the underlying computing device,
a characteristic of a hardware configuration of the underlying computing device, or
a characteristic of a network configuration of the underlying computing device.

14. The system of claim 12, wherein said scanning comprises:
determining whether a computing device is equipped with the software installation or the upgrade to the existing software installation.

15. The system of claim 14, wherein said determining is based on, at least in part, the respective tags assigned to each computing device.

16. The system of claim 14, wherein each computing device is initially assigned one or more tags, and wherein each computing device can have an increased number of tags after initial assignment of the one or more tags.

17. The system of claim 12, wherein the operations comprise:
determining a workload for scanning the network of computing devices and processing the scanning results; and
dividing the workload among the plurality of worker threads for scanning and processing the results of said scanning in parallel.

18. The system of claim 17, wherein the operations comprise:
responsive to changes in the workload for said scanning and processing, adding one more worker thread to, or removing one worker thread from, the plurality of worker threads.

19. The system of claim 17, wherein the operations comprise:
shuffling the plurality of worker threads when scanning the network of computing devices and processing the results thereof after the scanning has started.

20. One or more non-transitory computer storage media encoded with computer program instructions that when executed by one or more computers cause the one or more computers to perform operations comprising:
scanning, using a set of worker threads, the network of computing devices to access respective tags assigned to each computing device, wherein each computing device has been tagged based on one or more features specific to each computing device;
processing, using the set of worker threads, results of said scanning in accordance with a decision-tree based logic that accords weights to a plurality of factors when identifying an indication of malware presence or absence, on each computing device; and
responsive to identifying an indication of malware presence or absence, rescheduling an update for at least one computing device of the network of computing devices, wherein the update comprises a software installation or an upgrade to an existing software installation.
